(19) United States
(12) Patent Application Publication
(10) Pub. No.: US 2008/0208627 A1
(43) Pub. Date: Aug. 28, 2008

(54) Securing Pairing of Electronic Devices

(76) Inventor: Ole Skyggebjerg, Hillerod (DK)

Correspondence Address: NOVO NORDISK, INC.;INTELLECTUAL PROPERTY DEPARTMENT, 100 COLLEGE ROAD WEST, PRINCETON, NJ, 08540, US

(21) Appl. No.: 11/908,522

(22) PCT Filed: Mar. 14, 2006
(86) PCT No.: PCT/EP06/60675

§ 371 Date: Oct. 1, 2007

(30) Foreign Application Priority Data
Mar. 17, 2005 (DK) PA 2005 00385

(51) Int. Cl. G06Q 50/00

(52) U.S. Cl. 705/2

(57) ABSTRACT

The present invention relates to secure paring of electronically controlled devices adapted to communicate with each other. The invention provides a system comprising a local (200) unit and a remote (100) unit. The local unit comprises a local transmitter (270), a local receiver (280), a local sensor (290), and a local processor (210) connected to the local transmitter, the local receiver and the local sensor. The remote unit comprises a remote transmitter (170) adapted to transmit information to the local receiver (180), a remote receiver adapted for receiving information from the local transmitter, a remote sensor (190), and a remote processor (110) connected to the remote transmitter, the remote receiver and the remote sensor. The local sensor and the remote sensor are adapted to detect that the units have been arranged in a mating relationship with each other at a given point in time, this allowing the units to exchange information based upon that time.

The present invention generally relates to the secure paring of two electronically controlled devices adapted to communicate with each other. In a specific embodiment the invention relates to a medical delivery device in combination with a control unit for controlling the delivery device, however, the invention is applicable for all types of devices for which a secure pairing is an issue.

### BACKGROUND OF THE INVENTION

In the disclosure of the present invention reference is mostly made to the treatment of diabetes by infusion of insulin, however, this is only an exemplary use of the present invention.

Portable drug delivery devices for delivering a drug to a patient are well known and generally comprise a reservoir adapted to contain a liquid drug, a pump assembly for expelling a drug out of the reservoir and through the skin of the subject via a transcutaneous access device such as a soft cannula or a needle. Such devices are often termed infusion pumps.

Basically, infusion pumps can be divided into two classes. The first class comprises durable infusion pumps which are relatively expensive pumps intended for 3-4 years use, for which reason the initial cost for such a pump often is a barrier to this type of therapy. Although more complex than traditional syringes and pens, the pump offer the advantages of continuous infusion of insulin, precision in dosing and optionally programmable delivery profiles and user actuated bolus infusions in connections with meals. Such pumps are normally carried in a belt or pocket close to the body.

Addressing the above cost issue, several attempts have been made to provide a second class of drug infusion devices that are low in cost yet convenient to use. Some of these devices are intended to be partially or entirely disposable and may provide many of the advantages associated with an infusion pump without the attendant costs. For example, EP 1 177 802 discloses a skin-mountable drug infusion device which may have a two-part construction in which more expensive electronic components are housed in a reusable portion and the fluid delivery components are housed in a separable disposable portion (i.e. intended for single use only). U.S. Pat. No. 6,656,159 discloses a skin-mountable drug infusion device which is fully disposable.

The traditional durable pump may be worn in a belt at the waist of the user, this allowing the user to operate the pump by directly accessing the user interface on the pump, e.g. in order to change infusion rate or to program a bolus infusion. However, the pump may also be worn hidden under clothing this making operation more difficult. Correspondingly, it has been proposed to provide an infusion pump of the durable type with a wireless remote controller allowing the user to access some or all of the functionality of the pump, see for example U.S. Pat. No. 6,551,276, US 2005/0022274 and US 2003/0065308, which are hereby incorporated by reference, the latter disclosing an ambulatory medical device (MD) adapted to receive control messages from a communication device (CD). For a skin-mountable device, typically comprising an adhesive allowing the device to be attached directly to the skin of the user, a remote controller would appear even more desirable. Correspondingly, EP 1 177 802 and U.S. Pat. No. 6,740,059, which are hereby incorporated by reference, disclose semi-disposable and fully disposable infusion devices (which may be termed a local device or unit) which are intended to be operated primarily or entirely by a wireless remote controller (which may be termed a remote device or unit). As the delivery device thus does not have to be provided with a user interface such as a display and keyboard, the semi-disposable or disposable infusion can be provided more cost-effectively.

In order to provide safe operation of a given delivery device it is of utmost importance that control commands sent from a given remote control unit does only control actuation of the specific delivery device it is intended to control, and not some other delivery device in the proximity of the user. Further, as the delivery device may be adapted to transmit information back to the remote controller, it is also essential that such information is only received by the corresponding control unit. This issue is applicable to both durable systems and systems comprising disposable units. To provide the desired security the two devices intended to work together will normally be “paired” by exchange of information between the two devices, this allowing the information sent between the two devices to be specifically coded and thus only accepted by the correspondingly coded device. During a pairing process other information may also be transmitted between the two devices, e.g. the controller may be provided with information as to the type of delivery device in case different types of delivery devices are intended to be used with a given remote controller.

Having regard to the above, it is the object of the present invention to provide devices and methods allowing secure paring of two electronically controlled devices adapted to communicate with each other. It is a further object of the invention to provide such devices and methods which provide secure paring between devices relying fully or partly on wireless communication between the devices to be paired.

### DISCLOSURE OF THE INVENTION

In the disclosure of the present invention, embodiments and aspects will be described which will address one or more of the above objects or which will address objects apparent from the below disclosure as well as from the description of exemplary embodiments.

Thus, in a first aspect a system comprising a local unit and a remote unit is provided. The local unit comprises a local transmitter, a local receiver, a local sensor, and a local processor connected to the local transmitter, the local receiver and the local sensor. The remote unit comprises a remote transmitter adapted to transmit information to the local receiver, a remote receiver adapted for receiving information from the local transmitter, a remote sensor, and a remote processor connected to the remote transmitter, the remote receiver and the remote sensor. The local sensor and the remote sensor are adapted to detect that the local unit and the remote unit have been arranged in a mating relationship with each other at a given point in time, this allowing the units to exchange information based upon that time. In other words, by detecting the point in time where the two units are engaged with each other a time identification is established which is unique for the actual pairing of the two units and which can be used to either secure safe data transfer between the units or used to create unique code information. The time of engagement may either be used to start a clock or to determine a specific clock time, both of which can then be used subsequently by the system.

In the context of the present application and as used in the specification and claim, the term processor covers any combination of electronic circuitry suitable for providing the specified functionality, e.g. processing data and controlling memory as well as all connected input and output devices. The processor will typically comprise one or more CPUs or microprocessors which may be supplemented by additional devices for support or control functions. For example, the transmitter, the receiver and the sensor may be fully or partly integrated with the processor, or may be provided by individual units. Each of the components making up the processor circuitry may be special purpose or general purpose devices. A sensor may comprise a “sensor” per se, e.g. in the form of an electrical contact, or an optical or magnetic sensor capable of being influenced by the position of the other unit and adapted to produce a signal which can be recognized and processed by a processor. However, the sensor may also comprise or be associated with circuitry which detects and modifies a signal from a sensor per se before it is sent to the processor. Such circuitry may be formed integrally with the processor.

The above-described system is capable of determining a time of engagement by both of the units, however, dependent upon the desired type of time-based mating, the system may rely on both or only one of these time dependent determinations. Thus, alternatively the system may be provided with an engagement sensor in only one of the units, wherein the unit in which the sensor is arranged is adapted to detect that the two units have been arranged in a mating relationship with each other at a point in time, this allowing the unit comprising the sensor to exchange information based upon that time.

The sensors may be of any suitable type capable of identifying that the given unit has been engaged with a unit of a corresponding type, e.g. a given sensor may be a mechanical sensor, an electrical sensor, a magnetic sensor or a light sensor.

In an exemplary embodiment the local unit is adapted to transmit a unique identification (ID) code and the remote unit is adapted to receive and store this identification code. In case the code is transmitted by wire, i.e. by a galvanic contact established between the two units during the pairing process, the risk that a code from another (i.e. a “wrong”) local unit is transmitted to the remote unit is very limited, however, in case the code is transmitted by wireless means, e.g. by RF, optical (e.g. IR) or ultrasonic transmission, or by induction, there is the risk that the remote will detect a code sent from another local unit during the time the trans-mission of the code is intended to take place, i.e. “cross-talk” may take place and the wrong units will be paired with potentially serious consequences. Such a situation may e.g. take place in an instruction class in which a number of new pump users are taught how to use the system. In such a class the new users will typically be told to pair their remote unit with a corresponding local unit at the same time. Indeed, cross-talk may also take place in many other settings.

Correspondingly, in an aspect of the invention the remote unit is capable of receiving a code only within a time range determined by the point in time in which the remote unit detected that it was arranged in a mating relationship with the local unit. In other words, when the remote unit detects that it has been paired with a local unit it “opens a time window” during which it will “listen” for the transmission of a code of appropriate type.

In order to secure that the code is transmitted during the same period, the local unit may be adapted to transmit the code only within a time range (window) determined by the point in time in which the local unit detected that the local unit was arranged in a mating relationship with the remote unit. In order to provide a mutual engagement in which the local sensor and the remote sensor detect that the two units have been arranged in a mating relationship with each other at substantially the same time, the local unit and the remote unit may be provided with a mating “snap” coupling. Such a near-simultaneous opening of the two windows would provide both an efficient and secure pairing. If the system is designed to operate with narrow windows a high degree of safety against cross-talk is provided as the likelihood of two persons in the same room, or otherwise close to each other, will connect their two units at exactly the same time is small.

Although a narrow window will minimize the risk of cross-talk, the remote unit may be adapted to receive and detect at least two ID codes within the time range, this allowing the remote unit to produce a signal indicative of a situation in which the remote unit has received at least two ID codes within the time range. By allowing the remote unit to detect at least two ID codes within the time range, it can be prevented that an ID code received from another local unit first accidentally is accepted as the proper ID code from the mated local unit. The signal may be used to abort the pairing process and indicate to the user that the two units have to be connected again to open a new time window.

To avoid cross-talk the window should be as narrow as possible, however, depending on the actual electronics (hardware as well as software), it may take some seconds before the two systems are prepared to transmit and receive data, thus, the window may be open for e.g. 10, 5, 2 or 1 second.

The local sensor and the remote sensor may also be adapted to detect that the two units are no longer arranged in a mating relationship with each other, this allowing the units to detect the time in which they were engaged.

Correspondingly, in a further aspect of the invention the local unit and the control unit exchange time dependent information with each other when in the engaged state, where the time dependent information is indicative of the period of time the local unit and the remote unit have been in the engaged state. As the time dependent information is exchanged between the two units as long as they are connected and thus reflects the actual time the two units were connected, this information can be used to create a code to be used in communication between the two units, either as an additional or a the only code. As the likelihood that two persons in the same room, or otherwise close to each other, will have their two units connected during the same amount of time is small, a high degree of safety is provided.

As a variation of the above embodiment, the disengagement of the two units may be used to start the transmission and listening windows. Indeed, this would require the use of stronger transmission signals.

One of the units may comprise a clock providing a clock time (e.g. 17:45:23) and be adapted to store and transmit a time code to the other unit indicative of the clock time at which the unit with the clock detected that it was arranged in a mating relationship with the other unit, the other unit being adapted to store the time code. Such a code may be used either as an additional or as the only code. In a system with a disposable pump unit the clock would be arranged in the durable remote unit, however, in a system comprising a durable pump, the clock may be arranged in the pump. As the likelihood that two clocks in different units will be perfectly synchronized and engaged at exactly the same “local” time is small, a high degree of safety is provided.

To further enhance safety against incorrect pairing, one of the units, e.g. the remote unit may be provided with a user actuatable control, e.g. a key, and the other unit may be provided with an indication means, e.g. visual, audible or tactile, where actuation of the control produces an indication that a control transmission has been received by the local unit.

The different aspects of the present invention may be adapted in a wide varity of systems in which safe pairing of units is of importance. In an exemplary embodiment one or more of the above-disclosed aspects are implemented in a system where the local unit comprises a reservoir adapted to contain a fluid drug, as well as a pump assembly controlled by the local processor for dispensing drug from the reservoir. The reservoir may be any suitable structure adapted to hold an amount of a fluid drug, e.g. a hard reservoir, a flexible reservoir, a distensible or elastic reservoir. The reservoir may e.g. be prefilled, user fillable or in the form of a replaceable cartridge which again may be prefilled or fillable. The pump may be of any desired type, e.g. a membrane pump, a piston-cylinder pump or a roller-tube pump. Advantageously, the local processor is adapted to receive flow instructions from the remote unit, and the remote unit comprises a user interface allowing a user to enter flow instruction for subsequent transmission to the local unit, e.g. programming a basal infusion rate profile or a bolus.

As used herein, the term “drug” is meant to encompass any drug-containing flowable medicine capable of being passed through a delivery means such as a cannula or hollow needle in a controlled manner, such as a liquid, solution, gel or fine suspension. Representative drugs include pharmaceuticals such as peptides, proteins, and hormones, biologically derived or active agents, hormonal and gene based agents, nutritional formulas and other sub-stances in both solid (dispensed) or liquid form. In the description of the exemplary embodiments reference will be made to the use of insulin. Correspondingly, the term “subcutaneous” infusion is meant to encompass any method of transcutaneous delivery to a subject.

### BRIEF DESCRIPTION OF THE DRAWINGS

In the following the invention will be further described with reference to the drawings, wherein

FIGS. 1-3 shows in perspective views sequences of use for a first embodiment of a drug delivery device,

FIG. 4 shows perspective view of the interior of the reservoir unit of FIG. 1,

FIG. 5 shows a schematic representation of a local unit and a remote unit, and

FIGS. 6A-6D show steps of the pairing procedure between a local unit and a remote unit.

In the figures like structures are mainly identified by like reference numerals.

### DESCRIPTION OF EXEMPLARY EMBODIMENTS

When in the following terms such as “upper” and “lower”, “right” and “left”, “horizontal” and “vertical” or similar relative expressions are used, these only refer to the appended figures and not to an actual situation of use. The shown figures are schematic representations for which reason the configuration of the different structures as well as there relative dimensions are intended to serve illustrative purposes only.

Before turning to the present invention per se, a system suitable to be used in combination therewith will be described, the system comprising a pump unit (i.e. local unit), a patch unit adapted to be used in combination with the pump unit, and a remote control unit for wireless communication with the pump unit.

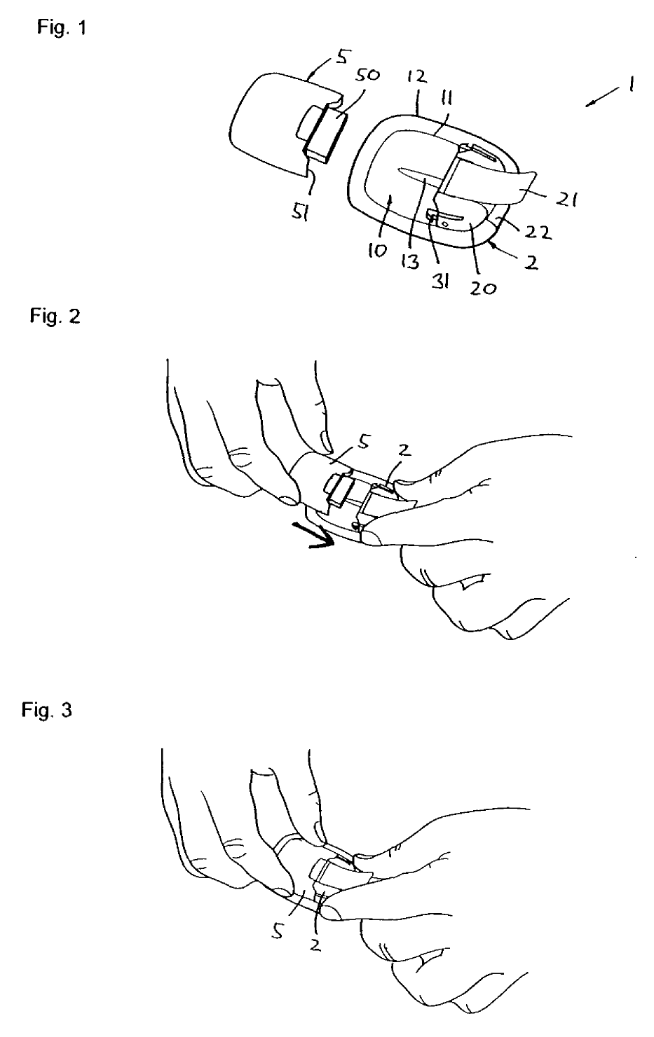

Firstly, with reference to FIGS. 1-3 an embodiment of a medical device for drug delivery will be described focusing primarily on the directly user-oriented features during application of the device to a skin surface. The patch unit 2 comprises a transcutaneous device in the form of a hollow infusion device, e.g. a needle or soft cannula, however, the needle or cannula may be replaced with any desirable transcutaneous device suitable for delivery of a fluid drug or for sensing a body parameter. For example, applicants PCT/EP2006/050410, hereby incorporated by reference, discloses an alternative configuration in which the patch unit comprises a soft cannula.

More specifically, FIG. 1 shows a perspective view of medical device in the form of a modular skin-mountable drug delivery device 1 comprising a patch unit 2 and a pump unit 5 (as the pump unit comprises a reservoir it may also be termed a reservoir unit). When supplied to the user each of the units are preferably enclosed in its own sealed package (not shown). The embodiment shown in FIG. 1 comprises a patch unit provided with an insertable transcutaneous device, e.g. needle, cannula or sensor. In case an actual embodiment requires the patch unit to be mounted on the skin and the transcutaneous device inserted before a pump or other unit can be attached, it follows that the method of use would be adopted correspondingly.

The patch unit comprises a flexible patch portion 10 with a lower adhesive mounting surface adapted for application to the skin of a user, and a housing portion 20 in which a transcutaneous device (not shown) is arranged. The transcutaneous device comprises a pointed distal end adapted to penetrate the skin of a user, and is adapted to be arranged in fluid communication with the pump unit. In the shown embodiment the pointed end of the transcutaneous device is moveable between an initial position in which the pointed end is retracted relative to the mounting surface, and an extended position in which the pointed end projects relative to the mounting surface. The transcutaneous device may also be moveable between the extended position in which the distal end projects relative to the mounting surface, and a retracted position in which the distal end is retracted relative to the mounting surface.

The patch unit further comprises user-gripable actuation means in the form of a first strip-member 21 for moving the transcutaneous device between the initial and the second position when the actuation means is actuated, and a user-gripable second strip-member 22 for removing the patch from the skin surface. The second strip may also me used to move the distal end of the transcutaneous device between the extended and the retracted position. The housing further comprises user-actuatable male coupling means 31 in the form of a pair of resiliently arranged hook members adapted to cooperate with corresponding female coupling means on the pump unit, this allowing the pump unit to be releasable secured to the patch unit in the situation of use. A flexible ridge formed support member 13 extends from the housing and is attached to the upper surface of the patch. The adhesive surface is supplied to the user with a peelable protective sheet.

The pump unit 5 comprises a pre-filled reservoir containing a liquid drug formulation (e.g. insulin) and an expelling assembly for expelling the drug from the reservoir through the needle in a situation of use. The reservoir unit has a generally flat lower surface adapted to be mounted onto the upper surface of the patch portion, and comprises a protruding portion 50 adapted to be received in a corresponding cavity of the housing portion 20 as well as female coupling means 51 adapted to engage the corresponding hook members 31 on the needle unit. The protruding portion provides the interface between the two units and comprises a pump outlet and contact means (not shown) allowing the pump to detect that it has been assembled with the patch.

In a situation of use the user assembles the two units which are then mounted on a skin surface where after the transcutaneous device is inserted and the pump is ready to operate. Operation may start automatically as the transcutaneous device is inserted, or the pump may be started via the remote unit, see below. Before the pump unit is mounted to the patch unit, the user will normally have paired the pump unit with the remote unit, see below. In an alternative situation of use the user may first mount the patch unit to a skin surface and insert the transcutaneous device, after which the pump unit is mounted to the patch unit.

After the assembled device has been left in place for the recommended period of time for use of the patch unit (e.g. 48 hours)—or in case the reservoir runs empty or for other reasons—it is removed from the skin by gripping and pulling the retraction strip 22 which may also lead to retraction of the transcutaneous device. The pump unit may be removed from the patch unit before or after the patch unit is removed from the skin. Thereafter the pump unit can be used again with fresh patch units until it has been emptied or the patch has to be changed again.

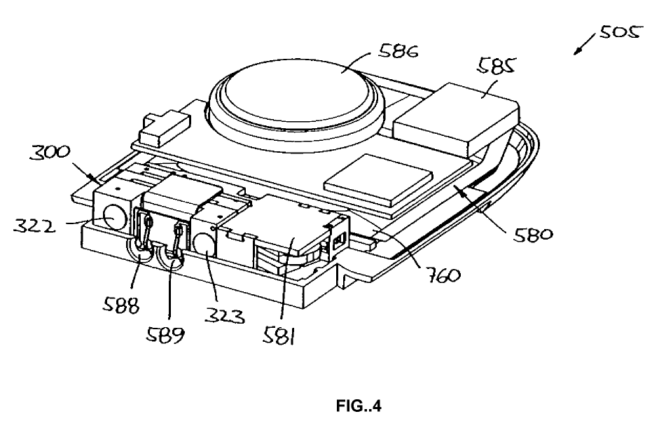

FIG. 4 shows the pump unit with an upper portion of the housing removed. The pump unit comprises a reservoir 760 and an expelling assembly comprising a pump assembly 300 as well as processor means 580 and a coil actuator 581 for control and actuation thereof. The pump assembly comprises an outlet 322 for connection to a transcutaneous access device and an opening 323 allowing a fluid connector arranged in the pump assembly to be actuated and thereby connect the pump assembly with the reservoir. The reservoir 560 is in the form of prefilled, flexible and collapsible pouch comprising a needle-penetratable septum adapted to be arranged in fluid communication with the pump assembly. The lower portion of the housing comprises a transparent area (not seen) allowing a user to inspect a portion of the reservoir. The shown pump assembly is a mechanically actuated membrane pump, however, the reservoir and expelling means may be of any suitable configuration.

The processor means comprises a PCB or flex-print to which are connected a microprocessor 583 for controlling, among other, the pump actuation, contacts (i.e. sensors) 588, 589 cooperating with corresponding contact actuators on the patch unit or the remote unit (see below), signal generating means 585 for generating an audible and/or tactile signal, a display (if provided), a memory, a transmitter and a receiver. An energy source 586 provides energy. The contacts may be protected by membranes which may be formed by flexible portions of the housing.

With reference to FIGS. 1-4 a modular local unit comprising a pump unit and a patch unit has been described, however, the local unit may also be provided as a unitary unit.

Although the present invention will be described with reference to the pump unit and the remote controller unit disclosed in FIGS. 1-6, it should be understood that the present disclosure is broadly applicable to any form of system comprising a pump unit in combination with a controller unit or other external unit, e.g. a PC or PDA. For example, the present disclosure may be used with programmable ambulatory insulin infusion pumps of the sort currently commercially available from a number of manufacturers, including without limitation and by way of example, Medtronic MiniMed under the trademark PARADIGM, Insulet Corporation under the trademark OmniPod, Smiths Medical under the trademark Deltec COZMO, and others, these pumps either being provided with a remote control or being adaptable to be used with one.

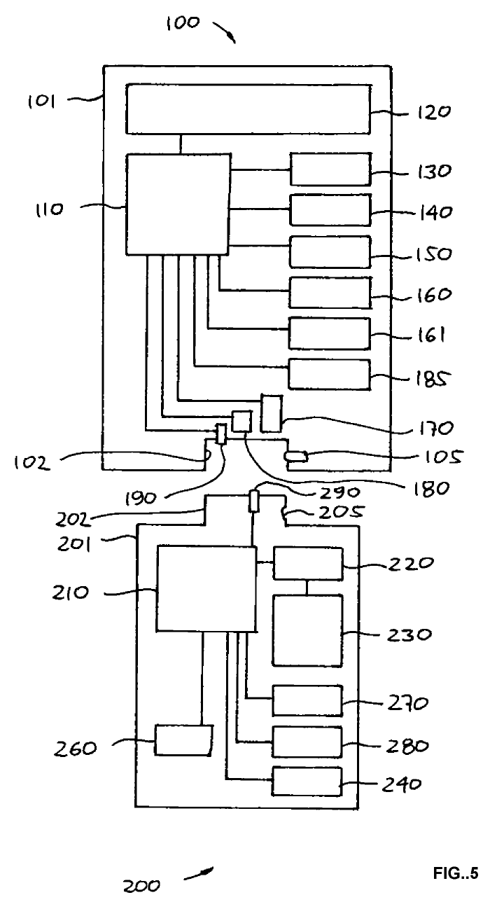

FIG. 5 shows a schematic representation of a local unit 200 (here corresponding to the pump unit 5 of FIG. 1) and a remote unit 100 (here in the form of a wireless “remote controller” or “external communication device” for the pump unit). It is considered that the general design of such units is well known to the skilled person, however, for a more detailed description of the circuitry necessary to provide the desired functionality of the present invention reference is made to incorporated US 2003/0065308.

More specifically, FIG. 5 depicts a simplified block diagram of various functional components or modules (i.e. single components or groups of components) included in the pump unit 200 and remote controller 100. The remote controller unit includes a housing 101 with a docking cavity 102 for a pump unit, a remote processor 110 including a CPU, memory elements for storing control programs and operation data and a clock, an LCD display 120 for providing operation for information to the user, a keypad 130 for taking input from the user, an audio alarm 140 for providing information to the user, a vibrator 150 for providing information to the user, a main battery 160 for supplying power to the controller, a backup battery 161 to provide memory maintenance for the controller, a remote radio frequency (RF) telemetry transmitter 170 for sending signals to the pump unit, a remote radio frequency (RF) telemetry receiver 180 for receiving signals from the pump unit, and a remote sensor 190 for detecting engagement with a pump unit. The controller further comprises a port 185, e.g. an infrared (IR) or RF input/output system, or a USB port for communicating with a further device, e.g. a blood glucose meter (BGM), a continuous blood glucose meter (CGM), a PC or a PDA.

As also depicted in FIG. 5, the pump unit 200 includes a housing 201 with a protruding docking portion 202, local processor electronics 210 including a CPU and memory elements for storing control programs and operation data, battery 260 for providing power to the system, a local RF telemetry transmitter 270 for sending communication signals to the remote unit, a local radio frequency (RF) telemetry receiver 280 for receiving signals from the remote unit, an audio alarm 140 for providing feedback to the user, reservoir 230 for storing a drug, pump assembly 220 for expelling drug from the reservoir through a transcutaneous device to the body of a patient, a local sensor 290 for detecting engagement with a remote unit. In alternative embodiments the pump unit may also comprise an LCD display for providing information to the user, a keypad for taking input from the user, and a vibrator or other tactile actuator for providing information to the user. RF transmission may be in accordance with a standard protocol such as Bluetooth (, see e.g. WO 2004/102897 disclosing an example of secure pairing of two devices using e.g. a Bluetooth (protocol.

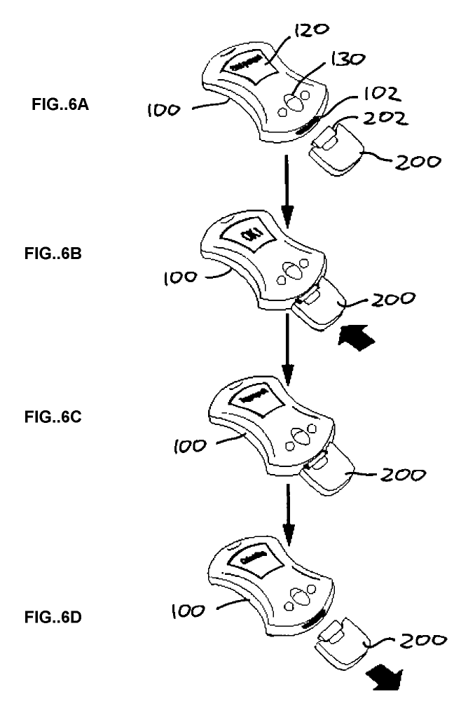

Turning to the pairing process per se, reference is made to FIGS. 6A-6D. In the shown embodiment the remote unit 100 comprises a docking cavity 102 adapted to accept a portion of the pump unit 200 which in the shown embodiment is a protruding portion 202 as also shown in FIG. 1. Before pairing the two units the user instructs the remote unit to go into “pairing mode” by using the display 120 and the soft-keys 130, FIG. 6A. The pairing may also be performed automatically when the pump unit is inserted, however, it is preferable that the remote unit is properly set up to pair with a new pump unit, e.g. the old pump unit should have been properly closed down and the data contained thereon stored in the remote unit for sub-sequent use. Depending on the actual design of the pump unit, the user may have to activate the pump in order to make the local sensor operatable, however, in the shown embodiment the local sensor is a mechanical contact that will allow power-up of the local processor when inserted in the remote unit, just as the activated sensor will detect that the local unit and the remote unit have been arranged in a mating relationship with each other, FIG. 6B. Correspondingly, the remote unit may comprise a sensor which automatically initiates the pairing process when the remote sensor detects that the local unit and the remote unit have been arranged in a mating relationship with each other. Alternatively the user may activate the “pre-engaged” remote sensor by operating the keypad.

When the pairing process has taken place the display may show e.g. “pairing successful remove pump unit”, FIG. 6C, after which the user removes the pump unit from the remote unit, FIG. 6D. During the pairing process a unique code has been created allowing the pump unit to be controlled only by the remote unit with which it was paired. In addition, information in respect of the pump may have been transferred to the remote control (e.g. type of pump, type of drug, size of reservoir, manufacturing date, etc.), and information in respect of the personal user settings stored in the remote unit may have been transferred to the pump unit (e.g. basal profile, etc.).

To further enhance secure pairing, the remote unit may prompt the user to test the pairing by actuating a key on the remote unit, this resulting in a confirming “beep” or the like from the pump unit indicating that the remote unit has been paired with the actual pump unit the user holds in the hand.

When the pump unit was removed from the remote unit, this was detected by the local sensor in the pump. Although the pump is now activated and ready for use, the pump is preferably prevented from pumping until the pump unit has been attached to a patch unit. The pump may then start automatically or first after having been started by the user via the remote controller unit.

As described above in the disclosure of the present invention, the pairing process using time information created during mating of the units may be utilized in a number of ways as will be described in the following by way of example. A given pairing set-up may utilize one or more of these processes.

### Example 1A

The local unit and the remote unit is provided with mating mechanical coupling means 105, 205 adapted to provide engagement in which the local sensor and the remote sensor detect that the local unit and the remote unit have been arranged in a mating relationship with each other at substantially the same time. The coupling is preferably of the “click” type in which the two units are “dragged” together during the final travel of engagement, e.g. when the pump unit is inserted into the docking cavity as shown in FIG. 6B. In case the pump unit is “dormant” it will need time to power-up before it can transmit the unique identification code embedded in the local processor. When power-up has taken place the pump unit will automatically start to transmit the code one or more times during a pre-specified interval, i.e. a transmission window. The control unit will be programmed to wait until the power-up has taken place before it will open a receiving window of a predetermined length. For example, the pump unit may start to transmit the code after 0.2 second and during the next 0.2 second. Correspondingly, the receiving window will be open in the interval 0.2-0.4 second after engagement. Depending on the actual electronics (hardware as well as software), power-up may take longer such that the window will be open for a longer period e.g. 10, 5, 2 or 1 second. As the receiving window is open for only a short while, the risk that the remote unit will receive a code from a nearby pump unit is greatly reduced. However, the longer the window is open the greater is the risk that a code from a different pump is received. Consequently, in case the remote unit has received two pairing codes within a receiving window, the remote unit will abort the pairing process and inform the user to re-connect for a second pairing attempt. After a code has been properly received, the code will form part of all communication between the remote unit and the pump unit as well as between the pump unit and the remote unit. To secure, that the pump unit is not activated accidentally it may go back to its dormant state unless it receives a “code received” or other information form a remote unit. To further reduce the risk of cross-talk during pairing of units, the two units may transmit signals at a low power level, e.g. using RF communication.

### Example 1B

As a variation of example 1A, the disengagement of the two units may be used to start the transmission and listening windows. Indeed, this would require the use of stronger transmission signals.

### Example 2

The local sensor and the remote sensor are also adapted to detect that the two units are no longer arranged in a mating relationship with each other, this allowing the units to detect the time in which they were engaged. Thus, when the two units are connected the remote unit starts to “listen” and the pump unit, after having been powered-up, starts to transmit the first of a coded sequence, e.g. “abxyz1” wherein “ab” indicates a code identifying a pump unit of a proper type, “xyz” is a unique code identifying the actual pump unit, and “1” indicates that this is the first of a series of signals. In case the unique pump code “xyz” has been exchanged during a previous pairing process, e.g. as in example 1, this portion of the code may be dispensed with. When the remote unit starts to listen, it will only accept the 1-coded sequence this preventing cross-talk with other pump units activated slightly earlier. When the 1-code is received it is returned to the pump unit as a “cdxyz1” code indicating that the previously 1-code has been accepted and returned from a remote unit of a proper “cd” type. There after the pump unit transmit the next “abxyz2” code in the sequence. This is repeated until the two units are disconnected. At this point the pump unit may have transmitted “abxyz16” and received “cdxyz16” (or “cdxyz15” if transmission was interrupted during a transmission cycle). The created code is now stored in both units after which the pump unit will only accept transmissions containing the code “xyz16” (or “xyz15” just as the remote unit will only accept transmissions containing the code “xyz15” (or “xyz16”). As appears due to interruption as well as potential sensor bounce, the code will have to be accepted within a pre-defined sequence of codes, however, still providing a very high degree of safety against pairing of a remote unit with a neighboring pump unit. In the above example a cycle frequency of 10 per second and an engagement duration of 1.5 second were used. Indeed, the faster the cycle frequency and the longer the engagement, the more unique will the created code be.

### Example 3

The remote unit is provided with clock circuitry providing a clock time (e.g. 17:45:23 or P05:45:23) and is adapted to store and transmit a time code to the pump unit indicative of the clock time at which the remote unit detected that it was arranged in a mating relationship with the pump unit, the pump unit being adapted to store the time code. For example, at 17:45:23 in accordance with the internal clock of the remote unit, the remote unit detects that a pump unit has been connected. The remote unit may wait e.g. 0.2 second allowing the pump unit to power up, after which a code based on the time value “17:45:23” is transmitted to the pump unit. Preferably the code is returned to the remote unit after which the two units are paired using “17:45:23” as a unique code. As the likelihood that two clocks in different remote units will be perfectly synchronized and engaged at exactly the same “local” time is small, a high degree of safety is provided.

In a further aspect, a remote unit may be provided with means allowing a user to check the condition of the drug to be infused, e.g. to check insulin for fibrillation.

Correspondingly, a system is provided comprising a pump unit in combination with a remote unit. The pump unit comprises an at least partially transparent reservoir adapted to contain a fluid drug, lighting means adapted for directing light through the drug, and a pump assembly for dispensing drug from the reservoir. The remote unit comprises a light source for directing light through the lighting means to the drug. The system further comprises detection means allowing a transmission characteristic of the light through the drug to be detected. The transmission characteristic may be any characteristic suitable of (i) being influenced by a relevant non-constant characteristic of the drug (e.g. fibrillation) and (ii) being detectable by either the user or detection means incorporated in the system, e.g. in the pump unit or the remote unit. For example, focused light or diffuse light would be dispersed in fibrillated insulin, the dispersion (at a given level) being visually identifiable by the user or other detection means.

In an exemplary embodiment the lighting means comprises a light conductor having a light inlet and a light outlet, the light conductor being adapted for conducting light from a point of entrance and into the reservoir, and wherein the detection means comprises a transparent area allowing a user to inspect a portion of the interior of the reservoir. In this way a light source arranged in the remote unit, e.g. in the form of a laser-LED or other LED, can be used to effectively lighten the reservoir for inspection. The light conductor may be straight or adapted to conduct light in a non-straight manner, e.g. it may be flexible or it may comprise facets redirecting light within the conductor. In the present context the term light conductor also covers the terms light guide and light pipe.

One or more light conductors may be arranged to substantially illuminate the interior of the reservoir, or one or more light conductors may be adapted to direct one or more beams of light through the reservoir. The light source may be arranged in the docking cavity 102 of the remote unit and the light inlet of the lighting means may correspondingly be arranged on the docking portion 202 of the pump unit. The light source may be activated automatically when the pump unit is connected to the remote unit or it may be activated by the user.

The above-described means for detecting a condition of a drug contained in the reservoir may be used for a combination of a pump and a remote unit comprising the above-described pairing means, or for any other combination of a remote unit and a pump unit comprising a drug-filled reservoir.

In the above description of the preferred embodiments, the different structures and means providing the described functionality for the different components have been described to a degree to which the concept of the present invention will be apparent to the skilled reader. The detailed construction and specification for the different components are considered the object of a normal design procedure performed by the skilled person along the lines set out in the present specification.

1. A system comprising a local unit (200) and a remote unit (100), the local unit comprising:
a local transmitter (270),
a local receiver (280),
a local sensor (290),
a local processor (210) connected to the local transmitter, the local receiver and the local sensor,
the remote unit comprising:
a remote transmitter (170) adapted to transmit information to the local receiver,
a remote receiver (180) adapted for receiving information from the local transmitter,
a remote sensor (190),
a remote processor (110) connected to the remote transmitter, the remote receiver and the remote sensor,
wherein the local sensor and the remote sensor are adapted to detect that the local unit and the remote unit have been arranged in a mating relationship with each other at a point in time, this allowing the units to exchange information based upon that time.

2. A system as in claim 1, wherein the local unit is adapted to transmit an ID code and the remote unit is adapted to receive and store the ID code.

3. A system as in claim 1, wherein the remote unit is capable of receiving an ID code only within a time range determined by the point in time in which the remote unit detected that the remote unit was arranged in a mating relationship with the local unit.

4. A system as in claim 3, wherein the local unit is adapted to transmit the ID code only within a time range determined by the point in time in which the local unit detected that the local unit was arranged in a mating relationship with the remote unit.

5. A system as in claim 1, wherein the remote unit is capable of receiving an ID code only within a time range determined by the point in time in which the remote unit detected that the remote unit was disengaged from a mated relationship with the local unit.

6. A system as in claim 5, wherein the local unit is adapted to transmit the ID code only within a time range determined by the point in time in which the local unit detected that the local unit was disengaged from a mated relationship with the remote unit.

7. A system as in claim 3, wherein the remote unit is adapted to receive and detect at least two ID codes within the time range, and wherein the remote unit is adapted to produce a signal indicative of a situation in which the remote unit has received at least two ID codes within the time range.

8. A system as in claim 1, wherein the length of the time range is selected from the group comprising: a length of less than 10 seconds, a length of less than 5 seconds, a length of less than 3 seconds, a length of less than 2 seconds, and a length of less than 1 second.

9. A system as in claim 1, wherein the local sensor and the remote sensor are adapted to detect that the local unit and the remote unit are no longer arranged in a mating relationship with each other.

10. A system as in claim 9, wherein the local unit and the control unit are adapted to exchange time dependent information with each other when in the engaged state, the time dependent information being indicative of the period of time the local unit and the remote unit have been in the engaged state.

11. A system as in claim 10, wherein the local unit and the control unit are adapted to store and use the time dependent information as a code to provide secure transmission between the local unit and the control unit.

12. A system as in claim 1, wherein one of the units comprises a clock providing a clock time and is adapted to transmit, and store, a time code to the other unit indicative of the clock time at which the unit comprising the clock detected that it was arranged in a mating relationship with the other unit, the other unit being adapted to store the time code.

13. A system as in claim 1, wherein the local unit and the remote unit comprises a mating mechanical coupling (105, 205) adapted to provide engagement in which the local sensor and the remote sensor detect that the local unit and the remote unit have been arranged in a mating relationship with each other at substantially the same time.

14. A system as in claim 1, wherein the local sensor and the remote sensor respectively are taken from the group consisting of a mechanical sensor, an electrical sensor, a magnetic sensor, and a light sensor.

15. A system as in claim 1, wherein the local transmitter and the remote receiver are adapted for wireless communication.

16. A system as in claim 1, wherein the remote transmitter and the local receiver are adapted for wireless communication.

17. A system as in claim 1, wherein the local unit comprises a reservoir (230) adapted to contain a fluid drug, and a pump assembly (220) controlled by the local processor for dispensing drug from the reservoir.

18. A system as in claim 17, wherein the local processor is adapted to receive flow instructions from the remote unit, and the remote unit comprises a user interface allowing a user to enter flow instruction for subsequent transmission to the local unit.

19. A system as in claim 1, wherein one of the units comprises a user actuatable control, and the other unit comprises an indication means, wherein actuation of the control produces an indication that a control transmission has been received by the other unit.

20. A system as in claim 1, wherein one of the units comprises a user actuatable control and an indication means, wherein actuation of the control produces an indication that a control transmission has been received and returned by the other unit.
